(19) United States
(12) Patent Application Publication
(10) Pub. No.: US 2004/0122710 A1
(43) Pub. Date: Jun. 24, 2004

(54) Method for paying for acquisition and use of medical equipment

(76) Inventor: Bo Holte, Charlottenlund (DK)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/325,533

(22) Filed: Dec. 19, 2002

(51) Int. Cl. G06F 17/60; G06F 17/00; G06G 7/00

(52) U.S. Cl. 705/2; 705/400

(57) ABSTRACT

A method by which a health care facility pays for the acquisition and use of medical equipment, the medical equipment having one or more functions that are carried out by the equipment, comprises the steps of determining a price per unit of use time for each function of the medical equipment, recording the amount of time each function of the medical equipment is used by the health care facility, computing the usage billing amount from the usage time and the price per unit of use time, and rendering a bill to the health care facility for the usage billing amount. Amounts for disposable/consumable supplies and for maintenance can also be determined.

### BACKGROUND OF THE INVENTION

The purchase of medical equipment used to diagnose or treat patients comprises a large part of the capital cost of operating a health care facility, such as a hospital. When the equipment is placed in use after acquisition there is a need to carry out proper cost accounting for its use for patient billing purposes.

The budgetary aspects of such costs are rendered continually more acute as the rising cost of acquiring and using medical equipment conflicts with health care cost restraints imposed by the consumers of health care and third party payors, such as insurance companies and governments.

### BRIEF SUMMARY OF TH INVENTION

The present invention is directed to a novel method for managing the costs of acquiring and using medical equipment. The invention provides significant advantages to health care facility purchasers of medical equipment, as well as to vendors of such equipment.

The method of the present invention is applicable to a wide variety of medical equipment, with equipment such as patient monitors, ventilators, and anesthesia machines being used for exemplary purposes in the present description.

Certain types of such equipment carry out a plurality of functions in use. For example, a patient monitor can monitor a variety of physiological characteristics, such as electrocardio phenomena, breathing rate, blood pressure, temperature, and the like.

In the method of the present invention, a medical equipment purchaser, such as a health care facility, and a vendor of such equipment establish, as through negotiation, a number of factors pertinent to the acquisition and use of the equipment. The factors are usually interrelated and typically include acquisition costs and terms for the equipment. Thus, the purchaser and vendor can negotiate for the outright purchase of the equipment, either for a lump sum or in installment payment. In another situation, the equipment can be leased.

A price per unit of time for the function or functions carried out or performed by the equipment is also established in the negotiations. For example, in the case of a patient monitor, a price per unit of use time may be established for electrocardiographic monitoring, such as $5.00 per day. A price per unit of time for blood pressure monitoring can also be established, and so on.

The combination of the pricing for the acquisition costs and the price per unit of usage time can be negotiated to meet the mutual needs of the health care facility purchaser and the medical equipment vendor. For example, by appropriately establishing the price per unit of usage time and the duration of a purchase and use agreement, the capital costs paid at the time of obtaining the equipment may be reduced. The parties may agree to a higher price per unit of usage time in return for smaller capital expense to the health care facility purchaser when acquiring the equipment. Or, capital expenses to the health care facility can be eliminated and payment for the equipment based solely on usage. In this case, the equipment could remain the property of the vendor.

Such arrangements benefit the health care facility in that the capital costs for the acquisition of the equipment can be reduced. Through the use of appropriate prices per unit of use time, cost accounting by the hospital can be simplified since appropriate charges based on such prices can be directly applied to specific patients. From the vendor's standpoint, the ability to offer a lower initial capital price for the equipment is an important selling feature when making a sale. Similarly, the overall arrangement provides the vendor with an opportunity to secure both a contract for the supply of disposable or consumable items used with the equipment and a maintenance/service agreement. This can result in a continuing income stream to the vendor.

Various other features, objects, and advantages of the invention will be made apparent from the following detailed description and the drawings.

### BRIEF DESCRIPTION OF THE DRAWINGS

The invention will be understood by reference to the following drawings and detailed description.

In the drawings:

FIGS. 1A and 1B is a flow chart illustrating the steps of the method of the present invention; and

FIG. 2 is a schematic diagram showing an apparatus suitable for carrying out the method of the present invention.

### DETAILED DESCRIPTION OF THE INVENTION

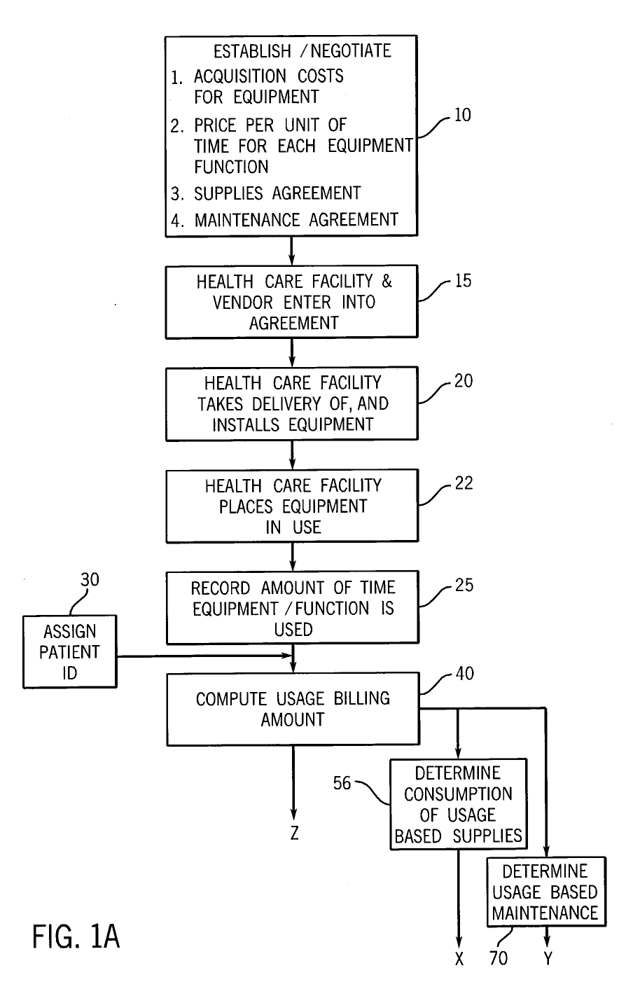

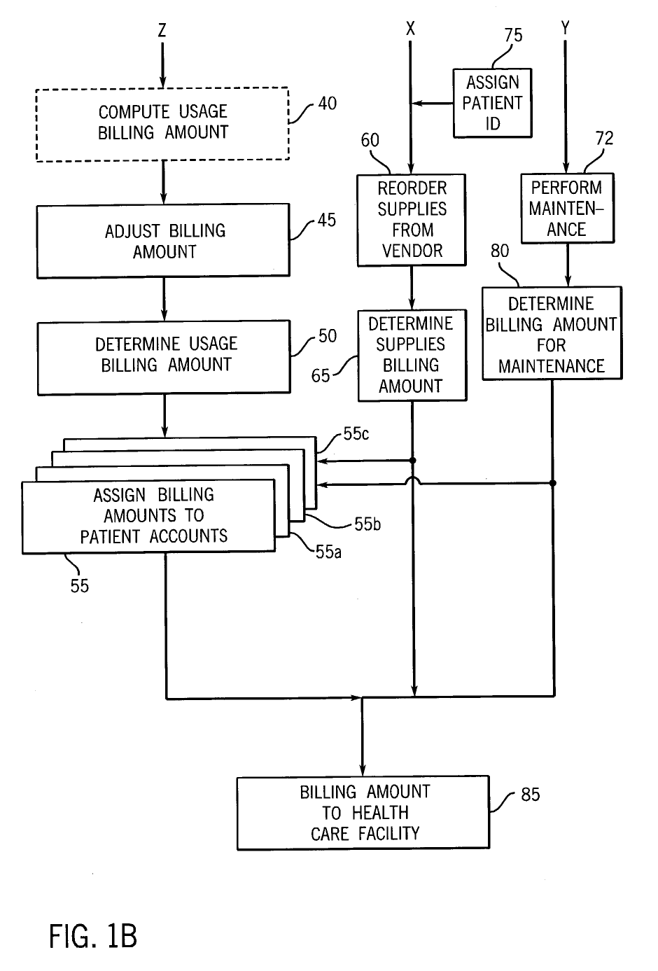

In the method of the present invention, the negotiation between the health care facility and medical equipment vendor is carried out in step 10 as shown in FIG. 1A. The negotiations are with a view to the health care facility obtaining medical equipment from the vendor. While the method of the present invention can be most easily visualized as involving a single piece of medical equipment, as a practical matter a number of pieces of the same equipment or a plurality of different equipment are usually involved in the transaction. For example, the health care facility may be seeking to replace all equipment of a given type, for example, patient monitors or anesthesian work stations, or to equip one or more facilities of a given type, such as operating rooms, which requires obtaining equipments of several different types. The parties can seek agreement on a number of factors. These may include acquisition costs for the medical equipment. The parties can also agree to a price per unit of time for each function performed by the equipment. For example, in the case of a patient monitor, a price per unit of use time may be established for electrocardiographic monitoring, such as $5.00/24 hours; a price for blood pressure monitoring, and so on. The costs to the health care facility may include a combination of up-front acquisition expenditures and price(s) fort of time charges. For continuing agreements, the duration of the agreement would also be negotiated.

The parties may also negotiate agreements for the purchase of disposable/consumable supplies, such as electrocardiographic electrodes, blood pressure transducers, and the like. For example, a price of $5.75 includes 24 hours of electrocardiographic monitoring plus one set of disposable electrodes/patient. The same is true with respect to a maintenance agreement providing for periodic and/or on-call servicing of the medical equipment. If desired, the costs for supplies and/or maintenance may be included in determining the price per unit of time for a function or functions performed by the equipment. As noted above, by appropriately establishing the price per unit of use time, the supplies agreement, and/or the maintenance agreement, the capital costs for the purchase of the equipment can be reduced or eliminated. For example, a price of $6.90 includes the foregoing monitoring and electrode items plus preventative maintenance every X hours. An inclusive price per unit of time simplifies billing to the health care facility and insures there are no unexpected bills to the health care facility for supplies or maintenance.

After the health care facility and the vendor have entered into the agreement, as at step 15 of FIG. 1A, the health care facility takes delivery of, and installs, the medical equipment at step 20 and places same in use at step 22.

The amount of time the equipment and each equipment function is used is recorded at step 25. This may be carried out by appropriate use time logging components in the equipment. The usage of the equipment so recorded may be supplied or assigned to the identification number of a specific patient at step 30. Thereafter, a usage billing amount for the equipment or function is computed at step 40 using the price per unit of time established in step 10 and the amount of time each equipment function is used, as determined in step 25.

As shown in FIG. 1B, the computed usage billing amount is then adjusted, if necessary, to fit local hospital billing and reimbursement requirements for health care services at step 45. A final usage billing amount is determined at step 50 and placed in specific patient accounts at steps 55a, 55b, and 55c etc.

If during the step 10, the parties negotiate agreements regarding the purchase of consumable supplies, then the use of the equipment may also be used to determine the consumption of such supplies at step 56. Additionally, or alternately, the amount of use time of each function may be employed to determine the consumption of supplies related to that given function. The consumption of some supplies, such as for example, electrocardiographic electrodes or blood pressure transducers, tend to be somewhat independent of the usage time of this equipment. The consumption of other supplies, such as IV solutions, is more closely related to use time. The consumption of either type of supply is determined in step 56. Supplies may be reordered from the vendor at step 60, either automatically based on the use, or as requested by the health care facility. The billing for supplies so consumed may be assigned to specific patient identifications at step 75, if desired, and assigned to patient accounts in step 55.

In a similar manner, if during step 10, the parties negotiate an agreement regarding usage-based maintenance, then the overall usage, or function-specific use times can be used to determine when maintenance is needed for each individual piece of medical equipment at step 70, which maintenance is carried out as at step 72. If the maintenance is not covered by a flat rate service agreement, the billing for maintenance of the equipment may be determined as step 80. If appropriate, the maintenance costs for the agreement can be assigned to specific patient identification and accounts in the same manner as direct usage time and disposable/consumable supplies.

The usage, supplies, and maintenance billings for all the equipment subject to the method of the present invention may be collected as at step 85 to generate the full billing to the health care facility by the medical equipment vendor.

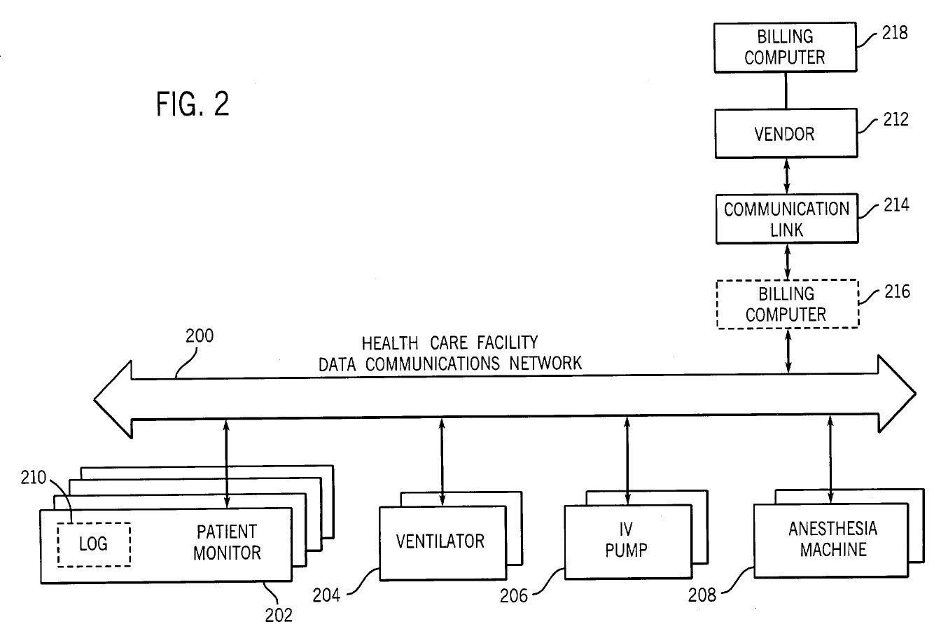

To carry out the method of the invention, and as shown in FIG. 2, each piece of equipment acquired by the health care facility and to which the method of the present invention is to be applied is placed in data communication with the health care facility data communications network 200. Thus, a plurality of exemplary equipment such as patient monitors 202, ventilators 204, IV pumps 206, and anesthesia machines 208 are connected to the health care facility data communication network 200.

The amount of time each equipment function is used is recorded as at step 25 (shown in FIG. 1A). The amount of usage time can be conveniently recorded in time recording or logging devices, such as logging device 210 schematically shown in connection with patient monitor 202. The logging device 210, for example, will record the amount of time that each patient monitor parameter (e.g. ECG, blood pressure, temperature, etc.) is carried out. The recording device, such as a logging device 210 shown for patient monitor 202 is connected to the hospital data communications network 200.

The logging devices periodically provide usage information to the health care facility data communications network 200. For example, the usage information may be provided to the data communications network 200 on a daily, weekly, or monthly basis for billing supplies consumption, and preventative maintenance purposes.

Certain devices, such as IV pumps may be disconnected from the network, for example, during patient transport, for specialized patient treatment, or for other reasons. The time recording devices, such as logging device 210, can record the usage time when disconnected and then download the usage data when the medical equipment is reconnected to health care facility data communications network 200.

The health care facility data communications network 200 is typically connected to vendor 212 through a communication link 214. The communication link can be a phone line, the Internet, or some other suitable means.

The computation of the billing amounts can be carried out either at the health care facility, as in a billing device, such as a computer 216, or at the vendor 212 in billing computer 218.

It is recognized that other equivalents, alternatives, and modifications aside from those expressly stated, are possible and within the scope of the appended claims. For example, while the method of the present invention has been described in terms of a vendor of medical equipment, it will be appreciated that payments may be made by the health care facility to another party, such as a finance company, or that orders for supplies may go to a local distributor. Also, the sequence of certain steps illustrated in FIG. 1 may be altered without departing from the present invention.

1. A method for determining amounts a health care facility pays for obtaining and use of medical equipment, the medical equipment having one or more functions that are carried out by the equipment, said method comprising the steps of:
determining a price per unit of use time for each function of the medical equipment;
recording an amount of time each function of the medical equipment is used by the health care facility;
computing a function-specific usage billing amount from the amount of time each function of the medical equipment is used and the price per unit of use time; and,
determining a payment amount for the health care facility for a total usage billing amount based on a sum of the function-specific usage billing amounts.

2. The method of claim 1 further comprising the steps of:
determining a consumption of disposable or consumable supplies particular to a given function;
determining a billing amount for such supplies; and,
adding the billing amount so determined to the payment amount for the health care facility.

3. The method of claim 1 further comprising the steps of:
establishing a consumption of disposable or consumable supplies particular to a given function;
determining a billing amount for such supplies; and,
including the billing amount so determined in the price per unit of time.

4. The method of claim 1 further defined as determining the consumption of disposable or consumable supplies based on the amount of time each function of the medical equipment is used.

5. The method of claim 2 further defined as determining the consumption of disposable or consumable goods based on an occurrence of the use of the equipment.

6. The method of claim 2 further comprising the step of reordering disposable or consumable supplies particular to the given function based on the consumption of such supplies.

7. The method of claim 2 further comprising the step of reordering disposable or consumable supplies particular to the given function based on an overall usage time of a given medical equipment.

8. The method of claim 6 wherein the consumable supplies are ordered automatically.

9. The method of claim 6 wherein the consumable supplies are ordered as requested by the health care facility.

10. The method of claim 1 further comprising the steps of:
determining when maintenance services are needed for a given medical equipment based on the overall usage of time of the equipment;
rendering the maintenance services:
determining a billing amount for such maintenance services; and,
adding the billing amount so determined to the payment amount for the health care facility.

11. The method of claim 1 further comprising the step of:
determining when maintenance is needed for a given medical equipment based on the amount of time a given function of the given medical equipment is used;
determining a billing amount for such maintenance services; and,
adding the billing amount so determined to the payment amount for the health care facility.

12. The method of claim 1 further comprising the step of:
determining when maintenance is needed for a given medical equipment based on the amount of time a given function of the given medical equipment is used;
establishing a billing amount for such maintenance services; and,
including the billing amount in the price per unit of time.

13. The method of claim 1 further comprising adjusting the usage billing amount to fit local hospital billing and reimbursement requirements for health care services.

14. The method of claim 1 further comprising assigning patient identification to the function-specific usage billing amounts.

15. A method by which a health care facility obtains and utilizes health care facility equipment from an equipment vendor, the medical equipment having one or more functions that are carried out by the equipment, the method comprising the steps of:
negotiating one or more of the following,
an acquisition cost for the equipment;
a price per unit of time for each function of the equipment; and
a duration of the time the equipment is available to the health care facility;
taking delivery of the equipment;
recording an amount of time each particular function of the equipment is used;
determining a usage billing amount based on the price per unit time and the time each particular function of the equipment is used; and
determining a payment amount for the health care facility from usage billing amounts.

16. The method of claim 15 further comprising the step of:
determining a consumption of disposable or consumable supplies particular to a given function determining a billing amount for such supplies; and,
adding the billing amount so determined to the payment amount for the health care facility.

17. The method of claim 15 wherein the step of negotiating the price per unit of time for each function of the equipment is further defined as including amounts for disposable or consumable supplies and/or maintenance services in the price per unit of time.

18. The method of claim 16 further defined as determining the consumption of disposable or consumable supplies based on the amount of time each function of the medical equipment is used.

19. The method of claim 16 further defined as determining the consumption of disposable or consumable goods based on an occurrence of the use of the equipment.

20. The method of claim 16 further comprising the step of reordering disposable or consumable supplies particular to the given function based on the consumption of such supplies.

21. The method of claim 19 wherein the disposable or consumable supplies are ordered automatically.

22. The method of claim 19 wherein the consumable supplies are ordered as requested by the health care facility.

23. The method of claim 15 further comprising the step of:
determining when maintenance services are needed for a given medical equipment based on the overall usage time of the equipment;
rendering the maintenance services;
determining a billing amount for such maintenance services; and,
adding the billing amount so determined to the payment amount for the health care facility.

24. The method of claim 15 further comprising the step of determining when maintenance is needed for a given medical equipment based on the amount of time given function of the given medical equipment is used.

25. The method of claim 15 further comprising adjusting the usage billing amount to fit local hospital billing and reimbursement requirements for health care services.

26. The method of claim 15 further comprising assigning patient identification to the function-specific usage billing amounts.
